(19) United States
(12) Patent Application Publication
(10) Pub. No.: US 2024/0377957 A1
(43) Pub. Date: Nov. 14, 2024

(54) STORAGE SYSTEM AND METHOD FOR CONTROLLING STORAGE SYSTEM

(71) Applicant: Hitachi, Ltd., Tokyo (JP)

(72) Inventor: Ryo IMANISHI, Tokyo (JP)

(21) Appl. No.: 18/599,584

(22) Filed: Mar. 8, 2024

(30) Foreign Application Priority Data
May 11, 2023 (JP) 2023-078812

(51) Int. Cl. G06F 3/06

(52) U.S. Cl. CPC G06F 3/0613; G06F 3/0631; G06F 3/067

(57) ABSTRACT

A storage having a cluster configuration is operated while stabilizing performance thereof. A storage system calculates a load value of a storage in which a predetermined cluster configuration is set, determines whether the calculated load value exceeds a predetermined value, adds a predetermined resource to the storage when the calculated load value exceeds the predetermined value, calculates a predicted value of a load of the storage when the resource is removed after the resource is added, determines whether the calculated predicted value is lower than a predetermined value, and removes the resource of the storage when the calculated predicted value is lower than the predetermined value.

### CROSS-REFERENCE TO RELATED APPLICATION

The present application claims priority pursuant to 35 U.S.C. § 119 to Japanese Patent Application No.: JP 2023-078812, filed on May 11, 2023, the entire disclosure of which is hereby incorporated herein by reference.

### BACKGROUND OF THE INVENTION

### 1. Field of the Invention

The present invention relates to a storage system and a method for controlling the storage system.

### 2. Description of Related Art

A technique of constructing a storage (cloud storage) having a clustering configuration on a cloud has been developed.

For example, as a technique of controlling volume arrangement in a storage cluster that provides a virtual storage system, JP2022-110245A discloses a volume arrangement control method in which, when a new node (replaced or newly added storage node) is added to the storage cluster, the storage system compares a specification of the new node with a specification of at least one existing node other than the new node, and when the specification of the new node is higher than the specification of the existing node, the storage system determines a transfer destination of a first volume (a volume associated with a priority higher than a first priority) to the new node if any existing node has the first volume.

### CITATION LIST

### Patent Literature

PTL 1: JP2022-110245A

### SUMMARY OF THE INVENTION

When a user of a storage cloud wants to use the storage cloud comfortably using a public cloud or the like, it is preferable to add or remove a resource of a storage according to circumstances of the user, especially to add or remove the resource to ensure temporary performance, even in a situation where data is written by the user. However, at present, a technique of reliably executing such addition or removal while limiting a decrease in performance (so as to remove an I/O load) has not been sufficiently developed.

The present invention has been made in view of such a background, and an object thereof is to provide a storage system capable of operating a storage having a cluster configuration while stabilizing performance thereof, and a method for controlling the storage system.

According to one aspect of the invention for solving the above problem, there is provided a storage system including: an arithmetic device configured to execute addition processing of calculating a load value of a storage in which a predetermined cluster configuration is set, determining whether the calculated load value exceeds a predetermined value, and adding a predetermined resource to the storage when the calculated load value exceeds the predetermined value, and removal processing of calculating a predicted value of a load of the storage when the resource is removed after the resource is added, determining whether the calculated predicted value is lower than a predetermined value, and removing the resource of the storage when the calculated predicted value is lower than the predetermined value.

According to the present invention, it is possible to operate a storage having a cluster configuration while stabilizing performance thereof.

Configurations, effects, and the like other than those described above will become apparent in the following description of an embodiment.

### BRIEF DESCRIPTION OF THE DRAWINGS

FIG. 1 is a diagram illustrating an example of a configuration of an information processing system according to the present embodiment;

FIG. 2 is a diagram illustrating main functions of a service portal platform;

FIG. 3 is a diagram illustrating an example of a host management table;

FIG. 4 is a diagram illustrating an example of a threshold management table;

FIG. 5 is a diagram illustrating an example of a hardware configuration of each information processing device constituting the information processing system;

FIG. 6 is a diagram illustrating an overview of storage control processing executed in the information processing system;

FIG. 7 is a flowchart illustrating an example of configuration information acquisition processing;

FIG. 8 is a diagram illustrating an example of a storage node management table;

FIG. 9 is a flowchart illustrating an example of measurement processing;

FIG. 10 is a diagram illustrating an example of an IOPS measurement result management table;

FIG. 11 is a flowchart illustrating details of addition-removal processing;

FIG. 12 is a flowchart illustrating details of addition determination processing;

FIG. 13 is a flowchart illustrating details of resource addition determination processing; and

FIG. 14 is a flowchart illustrating details of removal determination processing.

### DESCRIPTION OF EMBODIMENTS

Hereinafter, an embodiment of the invention will be described with reference to the drawings.

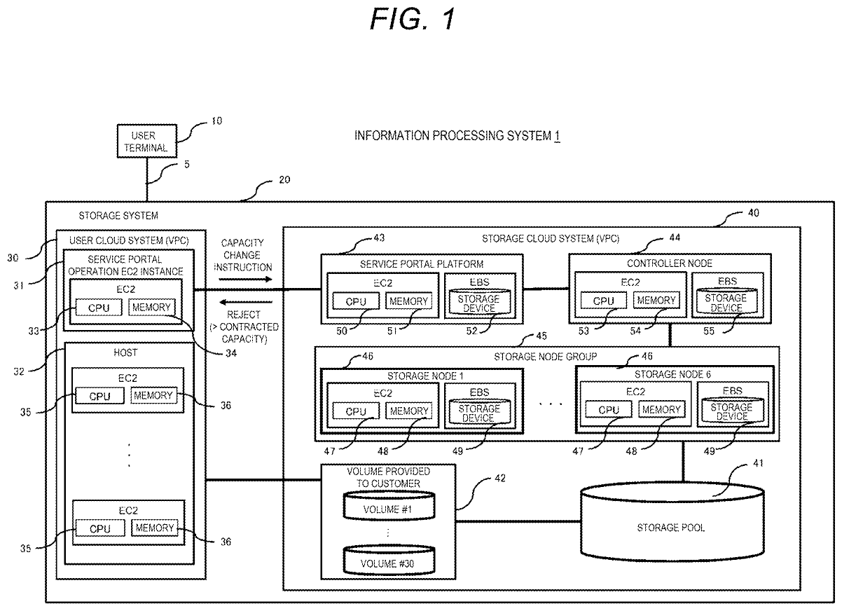

FIG. 1 is a diagram illustrating an example of a configuration of an information processing system 1 according to the present embodiment. The information processing system 1 includes one or more user terminals 10 to be used by users, and a storage system 20 that provides the user with a volume 42 generated based on a storage pool 41 to be described later. The storage system 20 and the user terminal 10 are communicably connected by a wireless or wired communication network 5 such as the Internet, a local area network (LAN), a WAN, or a dedicated line.

The storage system 20 is an information processing system (so-called public cloud) provided to the user by a predetermined business operator. The storage system 20 includes a user cloud system 30 that is accessed by the user terminal 10 and a storage cloud system 40 including the storage pool 41.

The user cloud system 30 includes a service portal operation instance 31 and a host 32 provided corresponding to the user (user terminal 10).

The service portal operation instance 31 transmits a volume control instruction to change a capacity of the volume 42 to a service portal platform 43 to be described later.

The host 32 can access the volume 42 to create and store data based on an input from the user terminal 10 or the like.

In the present embodiment, the service portal operation instance 31 and the host 32 are virtual servers (that is, including virtual CPUs 33 and 35 and memories 34 and 36) constructed based on one or more (physical) information processing devices, and may also be implemented as physical servers.

Next, the storage cloud system 40 includes the following systems: the service portal platform 43, a controller node 44, a storage node group 45, and the storage pool 41.

The storage pool 41 is a virtual storage constructed based on the storage node group 45 to be described later. The storage pool 41 is implemented as a storage having a predetermined cluster configuration (having redundancy). The storage pool 41 is constructed by allocating a plurality of storage nodes 46 of the storage node group 45. For example, the storage pool 41 has a cluster configuration including a predetermined number of data storages (data disks) and a predetermined number of parity storages (parity disks), and data is distributed and stored in each cluster.

The volume 42 includes one or more storage areas reconfigured based on the storage pool 41 (so-called storage cloud). The user terminal 10 can access the volume 42 via the host 32.

The service portal platform 43 executes capacity change processing related to the volume 42. That is, based on a volume change instruction received from the service portal operation instance 31, the service portal platform 43 instructs the controller node 44 to change the capacity of the volume 42 to a capacity indicated by the volume change instruction, and the controller node 44 executes the change. On the other hand, when the capacity indicated by the volume change instruction exceeds a predetermined capacity (contracted capacity) associated with the host 32 (user) in advance, the service portal platform 43 rejects the instruction. The contracted capacity can be acquired from, for example, a host management table 100 to be described later.

The service portal platform 43 instructs the controller node 44 to change a resource of the storage pool 41. Based on the instruction, the controller node 44 controls the storage node group 45 to change the resource of the storage pool 41. In the present embodiment, changing the resource includes increasing or reducing the number of (adding or removing) storage nodes 46 allocated to the storage pool 41 and improving or decreasing performance of a CPU 47 and a memory 48 to be described later of the storage node 46, and may include adding or removing other resources. When changing the resource, the capacity of the storage pool 41 provided to the user (the capacity provided to the user as the volume 42) is not to be changed.

The controller node 44 controls the storage node group 45 based on the instruction received from the service portal platform 43.

In the present embodiment, the service portal platform 43 and the controller node 44 are virtual servers (that is, including virtual CPUs 50 and 53, memories 51 and 54, and storage devices 53 and 55) constructed based on one or more (physical) information processing devices, and may also be implemented as physical servers.

The storage node group 45 implements a public cloud as described above, and includes the plurality of storage nodes 46 that are communicably connected to one another. The storage node 46 is a storage that is a resource allocated to the storage pool 41 to be used by the user. In the present embodiment, the storage nodes 46 are virtual servers (that is, including virtual CPUs 47, memories 48, and storage devices 49) constructed based on one or more (physical) information processing devices, and may also be implemented as physical servers.

Next, functions of the service portal platform 43 will be described.

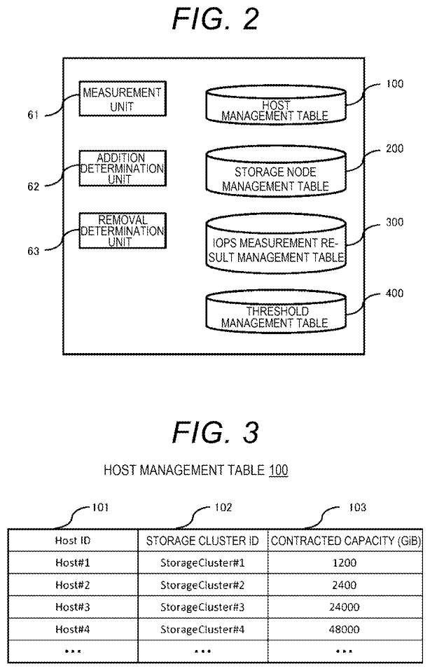

FIG. 2 is a diagram illustrating main functions of the service portal platform 43.

The service portal platform 43 stores the host management table 100 that stores information on a cluster (hereinafter referred to as a storage cluster) of the storage pool 41 allocated to each host 32, a storage node management table 200 that stores a configuration of the storage node 46, an IOPS measurement result management table 300 that accumulates a measurement result of a load of each cluster of the storage pool 41, and a threshold management table 400 that stores information on a pattern of a threshold (hereinafter referred to as a threshold rule) for determining whether to change a configuration of the storage cluster of the storage pool 41 based on the measurement result of the load. The service portal platform 43 stores in advance a threshold rule to be used (hereinafter referred to as a usage rule) among threshold rules stored in the threshold management table 400.

Next, the service portal platform 43 includes the following functional units: a measurement unit 61, an addition determination unit 62, and a removal determination unit 63.

The measurement unit 61 calculates a load value of the storage pool 41 (the storage node 46 in which a predetermined cluster configuration is set). In the present embodiment, the load value is a value (a value from 0% to 100%) obtained by dividing a measured value, of the number of times (input/output per second: IOPS) that data access (data reading or data writing) to the storage node 46 is possible per second, by the maximum number of times (the number of times when the maximum performance is exhibited), and other indexes may be used.

Specifically, first, the measurement unit 61 calculates a performance value of data access to the storage node 46 in a predetermined period, and calculates an accumulated value of a difference amount between the calculated performance value and a predetermined threshold (hereinafter referred to as an addition IO load threshold) in the predetermined period.

In the present embodiment, the measurement unit 61 calculates an accumulated value (hereinafter referred to as a read excess area) corresponding to a performance value related to data reading and an accumulated value (hereinafter referred to as a write excess area) corresponding to a performance value related to data writing.

Then, the measurement unit 61 calculates, as the load value, a ratio of the calculated excess accumulated value (read excess area, write excess area) to an accumulated value (reference accumulated value) of a performance value in a period in which the performance value is a predetermined value (in the present embodiment, the performance value is 100%).

In the present embodiment, regarding the reference accumulated value, the measurement unit 61 calculates a reference accumulated value (hereinafter referred to as a read entire area) corresponding to the performance value related to data reading and a reference accumulated value (hereinafter referred to as a write entire area) corresponding to the performance value related to data writing. Then, regarding the above ratio (load value), the measurement unit 61 calculates a ratio (hereinafter referred to as a read excess ratio) corresponding to the performance value related to data reading and a ratio (hereinafter referred to as a write excess ratio) corresponding to the performance value related to data writing.

After the addition determination unit 62 adds a resource to the storage pool 41 as will be described later, the measurement unit 61 calculates a performance value of the storage pool 41 (storage node 46) when the resource is removed. In the present embodiment, the performance value is the number of times (IOPS) that data access (data reading or data writing) to the storage is possible per second, but other indexes may be used.

Specifically, after the addition determination unit 62 improves processing performance or adds a node as will be described later, the measurement unit 61 calculates predicted values of loads related to data reading and data writing when the processing performance is decreased or the node is removed.

Next, the addition determination unit 62 determines whether the load value calculated by the measurement unit 61 exceeds a predetermined value, and adds a predetermined resource to the storage pool 41 when the calculated load value exceeds the predetermined value.

Specifically, the addition determination unit 62 forms a new cluster by improving processing performance of the storage node 46 corresponding to the storage pool 41 (for example, improving processing performance of the CPU 47 and the memory 48) when the load value (read excess ratio) related to data reading calculated by the measurement unit 61 exceeds a predetermined value (hereinafter referred to as an addition excess threshold), and by adding the storage node 46 (for example, adding a new storage node 46 to the storage pool 41) so as to form a cluster of the storage pool 41 when the calculated load value (write excess ratio) related to data writing exceeds a predetermined value (addition excess threshold).

Next, the removal determination unit 63 determines whether the predicted value calculated by the measurement unit 61 is lower than a predetermined value (hereinafter referred to as a removal IO load threshold), and removes the resource of the storage pool 41 (storage node 46) when the calculated predicted value is lower than the predetermined value.

Specifically, when the predicted value related to data reading and data writing calculated by the measurement unit 61 is lower than the predetermined value, the removal determination unit 63 decreases the processing performance (for example, decreases the processing performance of the CPU 47 and the memory 48) or removes the node (for example, removes the storage node 46 from allocation to the storage pool 41).

### Host Management Table

FIG. 3 is a diagram illustrating an example of the host management table 100. The host management table 100 includes data items of a host ID 101 for setting an ID of the host 32, a storage cluster ID 102 for setting an identifier of a storage cluster set for the host 32, and a contracted capacity 103 for setting a capacity allocated to the host 32. For example, the host management table 100 may be set by an administrator, or the storage cloud system 40 may automatically acquire information and set the information in the host management table 100.

### Threshold Management Table

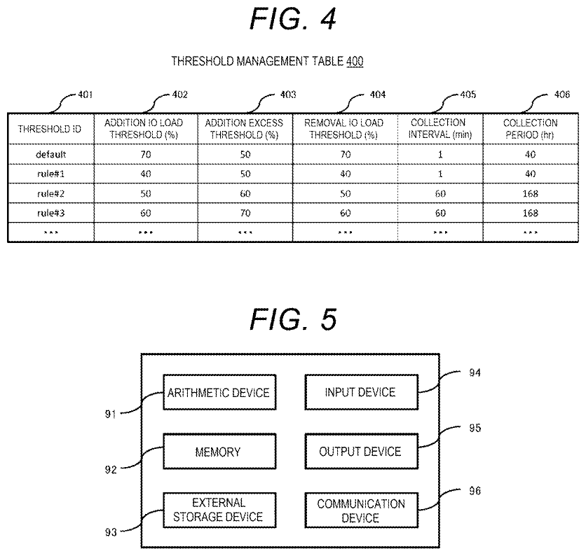

FIG. 4 is a diagram illustrating an example of the threshold management table 400. The threshold management table 400 includes data items of a threshold ID 401 for setting an ID of a threshold rule, an addition IO load 402 for setting an addition IO load threshold in the threshold rule, an addition excess threshold 403 for setting an addition excess threshold in the threshold rule, a removal IO load threshold 404 for setting a removal IO load threshold in the threshold rule, a collection interval 405 for setting a collection time interval (data collection interval) of data (performance value) in a period (measurement period) in which data on a load of data access is collected, and a collection period 406 for setting a period in which data (performance value) on a load of data access is collected.

The threshold management table 400 is preset by, for example, the administrator or the user. For example, the service portal platform 43 displays a predetermined screen and receives an input of each value from the administrator or the user. For example, the collection period is a time period from 9:00 to 17:00 on weekdays during a week, and the data collection interval is one minute. For example, the removal IO load threshold and the addition IO load threshold are any values from 40% to 100% (for example, 70%).

FIG. 5 is a diagram illustrating an example of a hardware configuration of (physical) each information processing device constituting the information processing system 1. The information processing device includes an arithmetic device 91 such as a central processing unit (CPU), a memory 92 such as a random access memory (RAM) or a read only memory (ROM), an external storage device 93 such as a hard disk drive (HDD) or a solid state drive (SSD), an input device 94 such as a keyboard, a mouse, or a touch panel, an output device 95 such as a display or a touch panel, and a communication device 96 including a network interface card (NIC), a wireless communication module, a universal serial interface (USB) module, a serial communication module, or the like. Functions of functional units of the information processing device (virtual server) in the information processing system 1 described above are implemented by the arithmetic device 91 reading programs from the memory 92 or the external storage device 93. Each program may be distributed by being recorded on a portable or fixed recording medium, for example.

Next, processing executed in the information processing system 1 will be described.

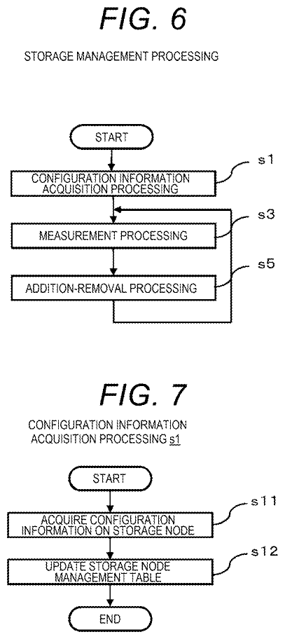

FIG. 6 is a diagram illustrating an overview of storage control processing executed in the information processing system 1.

First, the storage cloud system 40 executes configuration information acquisition processing s1 of acquiring configuration information on the storage node 46. The configuration information acquisition processing s1 is started, for example, when a predetermined input is made to the service portal platform 43.

After executing the configuration information acquisition processing s1, the storage cloud system 40 executes measurement processing s3 of measuring a current load of each cluster (storage node 46) of the storage pool 41. For example, the measurement processing s3 is repeatedly executed at a predetermined timing (such as a predetermined time or a predetermined time interval).

After executing the measurement processing s3 at least once, the storage cloud system 40 determines whether to change the resource of the storage pool 41 (for example, temporarily add or subsequently remove the storage node 46), and executes addition-removal processing s5 of changing the resource according to the determination result. The addition-removal processing s5 is repeatedly executed at a predetermined timing (such as a predetermined time or a predetermined time interval) after the measurement processing s3 is executed.

Hereinafter, the processing will be described in detail.

### Configuration Information Acquisition Processing

FIG. 7 is a flowchart illustrating an example of the configuration information acquisition processing s1. The service portal platform 43 acquires, from each storage node 46 of the storage node group 45, information on a configuration thereof and a storage cluster (s11), and records the acquired information in the storage node management table 200 (s12).

### Storage Node Management Table

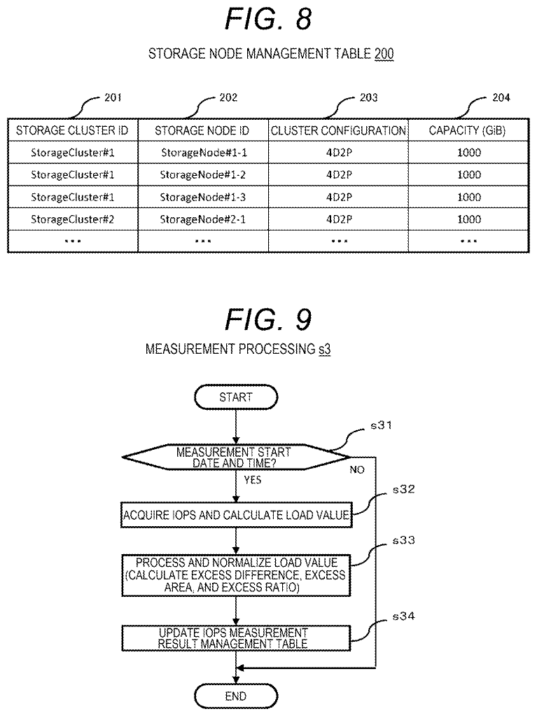

FIG. 8 is a diagram illustrating an example of the storage node management table 200. The storage node management table 200 includes data items of a storage cluster ID 201 for setting an ID of a storage cluster, a storage node ID 202 for setting the storage node 46 constituting the storage cluster, a cluster configuration 203 for setting a configuration of the storage cluster (for example, the number of data disks and the number of parity disks constituting the storage cluster), and a capacity 204 for setting a capacity of the storage node 46.

### Measurement Processing

FIG. 9 is a flowchart illustrating an example of the measurement processing s3.

The measurement unit 61 determines whether a current date and time are a measurement start date and time (s31). For example, the measurement unit 61 executes the determination based on a date and time in a preset schedule or a content of a record related to a usage rule in the threshold management table 400 in the collection period 406.

When the current date and time is the measurement start date and time (s31: YES), the measurement unit 61 executes the processing in s32. When the current date and time is not the measurement start date and time (s31: NO), the measurement processing s3 ends.

In s32, the measurement unit 61 measures data access to each storage cluster (storage node 46) during a measurement period to calculate a performance value.

For example, the measurement unit 61 calculates the performance value by performing data access (data reading and data writing) to the storage node 46, at each time of a data collection interval indicated by the collection interval 405 of the record related to the usage rule in the threshold management table 400, during the measurement period indicated by the collection period 406 of the record.

Then, the measurement unit 61 executes predetermined processing (normalization or the like) on the performance value calculated in s32 (s33).

Specifically, first, regarding data reading, the measurement unit 61 calculates “data reading performance value−addition IO load threshold” at each time in the measurement period as an addition excess difference. On the other hand, regarding data reading, the measurement unit 61 calculates “data reading performance value−removal IO load threshold” in each data collection period of the measurement period as a removal excess difference.

Then, the measurement unit 61 calculates a total value of all addition excess differences in the measurement period. That is, the measurement unit 61 calculates a read excess area for each data collection period for the addition excess difference.

Further, the measurement unit 61 calculates a total value of performance values in a period in which the addition excess difference is 0. That is, the measurement unit 61 calculates a read entire area for a period in which a load is 100%.

Then, the measurement unit 61 calculates a read excess ratio (that is, a load value) by dividing the read excess area by the read entire area.

On the other hand, regarding data writing, the measurement unit 61 also executes the same processing. That is, regarding data writing, the measurement unit 61 calculates “data writing performance value−addition IO load threshold” at each time in the measurement period as the addition excess difference. On the other hand, the measurement unit 61 calculates “data writing performance value−removal IO load threshold” in each data collection period of the measurement period as the removal excess difference.

Then, the measurement unit 61 calculates a total value of all addition excess differences in the measurement period. That is, the measurement unit 61 calculates a write excess area for each data collection period for the addition excess difference.

Further, the measurement unit 61 calculates a total value of performance values in a period in which the addition excess difference is 0. That is, the measurement unit 61 calculates a write entire area for the period in which the load is 100%.

Then, the measurement unit 61 calculates a write excess ratio (that is, the load value) by dividing the write excess area by the write entire area.

Next, the measurement unit 61 updates the IOPS measurement result management table 300 with each value calculated in s33 (s34).

### IOPS Measurement Result Management Table

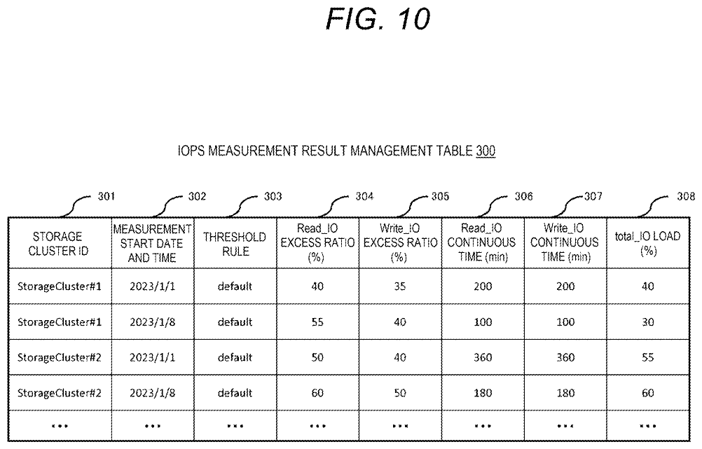

FIG. 10 is a diagram illustrating an example of the IOPS measurement result management table 300. The IOPS measurement result management table 300 includes data items of a storage cluster ID 301 for setting an ID of a storage cluster, a measurement start date and time 302 for setting a date and time (measurement start date and time) when measurement of a load of data access to the storage cluster is started, a threshold rule 303 for setting a designated threshold rule (usage rule), a read IO excess ratio 304 for setting a read excess ratio in a measurement period started from the measurement start date and time, and a write IO excess ratio 305 for setting a write excess ratio in the measurement period started from the measurement start date and time, a read IO continuous time 306 for setting a time (read excess continuous time) in which a load value related to data reading continuously exceeds an addition excess threshold in the measurement period started from the measurement start date and time, a write IO continuous time 307 for setting a time (write excess continuous time) in which a load value related to data writing continuously exceeds an addition excess threshold in the measurement period started from the measurement start date and time, and a total IO load 308 for setting a total IO load value.

In the processing in s34, for example, the measurement unit 61 sets the calculated read excess ratio in the read IO excess ratio 304 in the IOPS measurement result management table 300. The measurement unit 61 sets the calculated write excess ratio in the write IO excess ratio 305 in the IOPS measurement result management table 300.

The measurement unit 61 specifies a length of a time in which an addition excess difference (or a removal excess difference) continuously exceeds zero regarding data reading in the measurement period, and sets the specified length in the read IO continuous time 306. The measurement unit 61 specifies a length of a time in which an addition excess difference (or a removal excess difference) continuously exceeds zero regarding data writing in the measurement period, and sets the specified length as the write IO continuous time 307. The measurement unit 61 sets an average value (total IO load value) of performance values of data access (data reading and data writing) in the measurement period in the total IO load 308.

In the above description, the measurement unit 61 calculates the load value based on a value (read excess ratio, write excess ratio) normalized by the read entire area, the write entire area, or the like, but normalization may be omitted. The performance value may not be normalized either, and a value of the IOPS may be used.

### Addition-Removal Processing

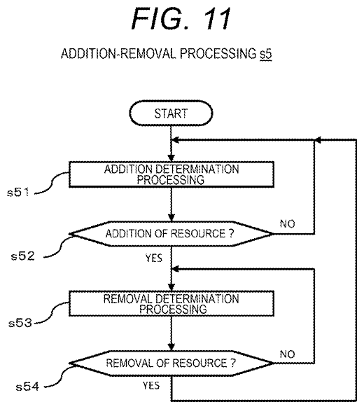

FIG. 11 is a flowchart illustrating details of the addition-removal processing s5.

First, the addition determination unit 62 determines whether to add a resource to the storage pool 41 based on the IOPS measurement result management table 300, and executes addition determination processing s51 for adding the resource when determining whether to add the resource. The addition determination processing s51 may be repeatedly executed.

When the resource is added by the addition determination processing s51 (s52: YES), the addition determination unit 62 executes removal determination processing s53, and when the resource is not added by the addition determination processing s51 (s52: NO), the addition determination unit 62 repeats the addition determination processing s51.

In s53, the removal determination unit 63 determines whether to remove the resource added (temporarily) by the addition determination processing s51 from the storage pool 41 based on the IOPS measurement result management table 300, and executes removal determination processing s53 for removing the resource when determining whether to remove the resource. The removal determination processing s53 may be repeatedly executed (however, the number of times of the repeated addition determination processing s51 is not to be exceeded).

When the resource is removed by the removal determination processing s53 (s54: YES), the removal determination unit 63 repeats the addition determination processing s51, and when the resource is not removed by the removal determination processing s53 (s54: NO), the removal determination unit 63 repeats the removal determination processing s53.

### Addition Determination Processing

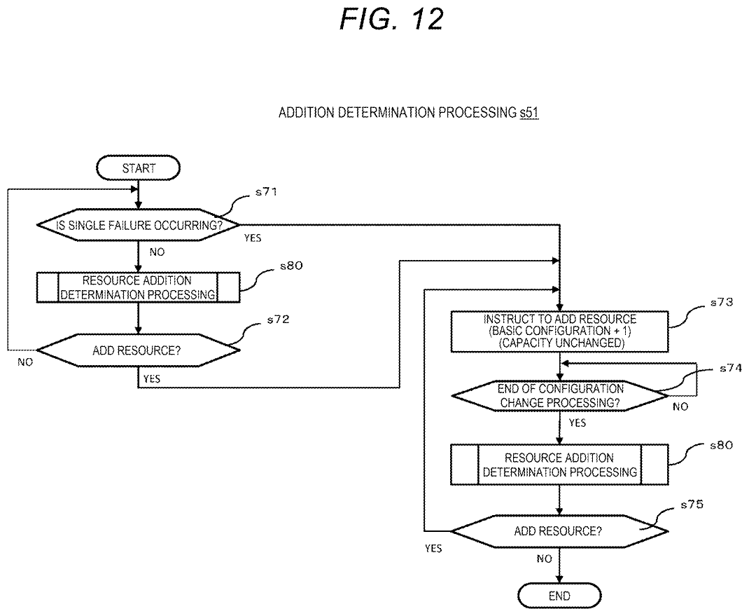

FIG. 12 is a flowchart illustrating details of the addition determination processing s51.

The addition determination unit 62 determines whether a failure (a failure in hardware, or a failure in the CPU 47, the memory 48, or the like) is currently occurring in any one of the storage nodes 46 (s71). For example, the addition determination unit 62 calls a predetermined monitoring tool provided in advance in the storage cloud system 40 and acquires failure information to determine presence or absence of a failure.

When a failure is currently occurring in any one of the storage nodes 46 (s71: YES), the addition determination unit 62 stores information indicating that a storage cluster is to be added as resource addition, and executes the processing in s73, and when no failure is currently occurring in the storage node 46 (s71: NO), the addition determination unit 62 executes the processing in s80.

In s80, the addition determination unit 62 executes resource addition determination processing s80 of determining whether to add a resource to the storage pool 41.

When determining to add the resource (s72: YES), the addition determination unit 62 executes the processing in s73, and when determining not to add the resource (s72: NO), the addition determination unit 62 repeats the processing in s71.

In s73, the addition determination unit 62 instructs the controller node 44 to add the resource based on a storage content in s71 or a storage content (to be described later) that is a processing result of the resource addition determination processing s80. Then, the addition determination unit 62 waits for receiving a processing end notification from the controller node 44 (s74: NO).

The controller node 44 executes processing based on the instruction received from the addition determination unit 62. For example, the controller node 44 newly allocates a predetermined number of storage nodes 46 to the storage pool 41 so as to maintain a current redundancy configuration of the storage pool 41. For example, when a current cluster configuration is a cluster including four data disks and two parity disks, the controller node 44 newly allocates the six storage nodes 46 including the four data disks and the two parity disks. The controller node 44 does not change a capacity itself of the storage pool 41. Information on redundancy of the storage pool is acquired from the storage node management table 200, for example.

For example, the controller node 44 improves performance of each of the CPU 47 and the memory 48 of the storage node 46 currently allocated to the storage pool 41 by a predetermined amount (for example, doubles a clock frequency and a storage capacity of the CPU).

When receiving the end notification from the controller node 44 (s74: YES), the addition determination unit 62 executes the resource addition determination processing s80.

Thereafter, when determining to add a resource in the resource addition determination processing s80 (s75: YES), the addition determination unit 62 repeats the processing in s73, and when it is determined that the resource is not to be added in the resource addition determination processing s80 (s75: NO), the addition determination processing s51 ends.

### Resource Addition Determination Processing

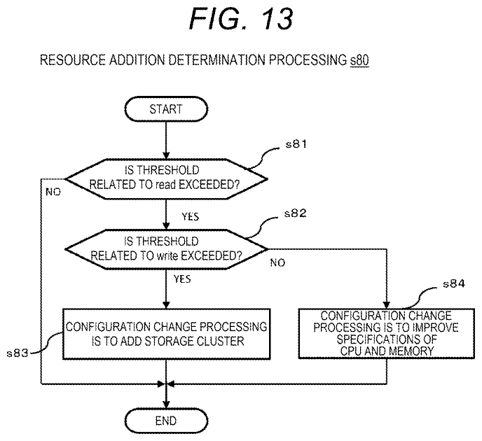

FIG. 13 is a flowchart illustrating details of the resource addition determination processing s80.

The addition determination unit 62 determines whether a load related to data reading to the storage cluster is large (s81). Specifically, the addition determination unit 62 refers to the latest record of each storage cluster in the IOPS measurement result management table 300, and determines whether a read IO excess ratio of each record exceeds a threshold indicated by the addition excess threshold 403 of the record related to the usage rule in the threshold management table 400.

When the load related to data reading to the storage cluster is large (s81: YES), the addition determination unit 62 executes the processing in s82, and when the load related to data reading to the storage cluster is not large (s81: NO), the addition determination unit 62 determines not to add the resource, and the resource addition determination processing s80 ends.

In s82, the addition determination unit 62 determines whether a load related to data writing to the storage cluster is large. Specifically, the addition determination unit 62 refers to the latest record of each storage cluster in the IOPS measurement result management table 300, and determines whether a write IO excess ratio of each record exceeds a threshold indicated by the addition excess threshold 403 of the record related to the usage rule in the threshold management table 400.

When the load related to data writing to the storage cluster is large (s82: YES), the addition determination unit 62 executes the processing in s83, and when the load related to data writing to the storage cluster is not large (s82: NO), the addition determination unit 62 executes the processing in s84.

In s83, the addition determination unit 62 stores information indicating that a storage cluster (storage node 46) is to be added as resource addition. With the above, the resource addition determination processing s80 ends.

In s84, the addition determination unit 62 stores information indicating that processing performance (performance of the CPU and the memory) is to be improved as resource addition. With the above, the resource addition determination processing s80 ends.

### Removal Determination Processing

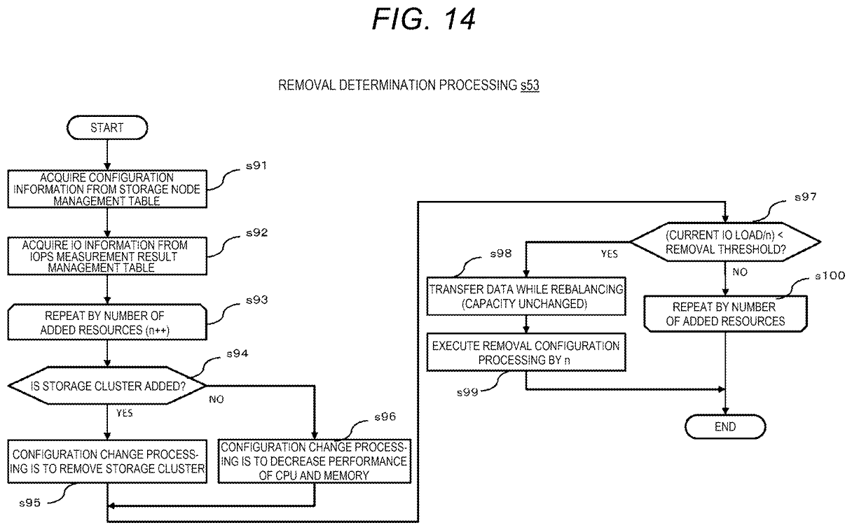

FIG. 14 is a flowchart illustrating details of the removal determination processing s53.

The removal determination unit 63 acquires information on a configuration of each storage node 46 (content of the cluster configuration 203) from the storage node management table 200 (s91).

The removal determination unit 63 acquires information on a load value related to each storage cluster (for example, a content of the latest record of the storage cluster) from the IOPS measurement result management table 300 (s92).

The removal determination unit 63 repeats the following processing in s94 to s97 by the number n of times of resource addition according to the addition determination processing s51 (s93, s100).

That is, the removal determination unit 63 determines whether a storage cluster (storage node 46) is added by the addition determination processing s51 (s94).

When the storage cluster is added (s94: YES), the removal determination unit 63 stores information indicating that the storage cluster is to be removed as resource removal (s95), and then executes the processing in s97. When the storage cluster is not added (s94: NO), the removal determination unit 63 stores information indicating that performance of the CPU and the memory is to be decreased as resource removal (step s96), and then executes the processing in s97.

In s97, the removal determination unit 63 determines whether to actually remove a resource corresponding to once resource addition according to the addition determination processing s51.

That is, the removal determination unit 63 determines whether the load related to data access (data reading and data writing) to the storage cluster when the resource is removed is small.

Specifically, the addition determination unit 62 refers to the latest record of each storage cluster in the IOPS measurement result management table 300, and determines whether a value obtained by dividing the read total IO load 308 of each record by n (a predicted value of the performance value after resource removal) is lower than a threshold indicated by the removal IO load threshold 404 of the record related to the usage rule in the threshold management table 400. The determination method described here is an example, and any method for predicting whether the performance value (or the load value) is equal to or greater than a certain value when the resource is removed can be adopted.

When the resource is to be removed (s97: YES), the removal determination unit 63 executes the processing in s98, and when the resource is not to be removed (s97: NO), the removal determination unit 63 executes the processing in s100.

In s98, when the information indicating that a storage cluster is to be removed is stored, the removal determination unit 63 first transfers data (target data) stored in the storage node 46 related to the storage cluster to be removed, among data in the storage nodes 46 currently allocated to the storage pool 41, to the storage nodes 46 (target nodes) related to storage clusters not to be removed. At this time, the removal determination unit 63 evenly distributes and transfers (rebalances) the target data to the target nodes.

Then, the removal determination unit 63 transmits an instruction to remove the resource stored in s95 or s96 to the controller node 44 together with the configuration information acquired in s91 (s99).

When receiving the instruction, the controller node 44 executes processing of removing the resource based on the instruction.

For example, when the information is stored indicating that a storage cluster is to be removed, the removal determination unit 63 removes the storage cluster (storage node 46) (for example, executes removal corresponding to the addition executed according to the addition determination processing s51). For example, when the information indicating that performance of the CPU and the memory is to be removed is stored, the removal determination unit 63 decreases performance of the CPU 47 and the memory 48 of the storage node 46 (for example, decreases the performance by the same amount as the improvement in the performance executed according to the addition determination processing s51). At this time, the controller node 44 does not change the capacity itself of the storage pool 41. With the above, the removal determination processing s53 ends.

As described above, the storage cloud system 40 according to the present embodiment calculates a load value of a storage (the storage pool 41 or the storage node 46) in which a predetermined cluster configuration is set, adds a predetermined resource constituting a cluster to the storage pool 41 when the calculated load value exceeds a predetermined value, calculates a predicted value of a load of the storage when the resource is removed after the resource is added, and removes the resource of the storage pool 41 (the storage node 46) when the calculated predicted value is lower than a predetermined value.

In this way, by adding the resource when the load of the storage pool 41 having the cluster configuration is large, and removing the resource when the load becomes small after resource addition and the processing becomes stable, performance of the storage pool 41 can be maintained with resources that are not excessive even when the load of the storage pool 41 temporarily increases.

As described above, according to the storage cloud system 40 in the present embodiment, it is possible to operate a storage having a cluster configuration while stabilizing performance thereof.

The storage cloud system 40 according to the present embodiment, in a case where the load value of the storage pool 41, in which predetermined processing performance (CPU and memory) and the predetermined cluster configuration are set, exceeds the predetermined value, improves the processing performance or adds the storage node 46 constituting a cluster of the storage pool 41, and in a case where the predicted value of the load of the storage when the processing performance is decreased or the node is removed, after the processing performance is improved or the node is added, is lower than the predetermined value, decreases the processing performance of the storage or removes the node of the storage.

In this way, by changing the processing performance or adding or removing the storage nodes 46 according to an increase or decrease in the load of the storage pool 41, it is possible to flexibly change the resource according to a magnitude of the increase or decrease in the load and operate the storage pool 41 while stabilizing performance thereof.

The storage cloud system 40 according to the present embodiment improves the processing performance when a load value related to data reading to the storage exceeds a predetermined value, adds the storage node 46 constituting the cluster of the storage when a load value related to data writing to the storage exceeds a predetermined value, and decreases the processing performance or removes the storage node 46 in a case where predicted values related to data reading and data writing, when the processing performance is decreased or the node is removed thereafter, are lower than predetermined values.

In this way, by only improving the processing performance when the load related to data reading is large, and adding the storage node 46 when the load related to data writing is large, it is possible to add an appropriate type of resource according to an importance of a magnitude of the load. Regarding resource removal, the resource removal is also determined based on loads related to data reading and writing. Accordingly, it is possible to further stabilize the performance of the storage.

When removing the storage node 46, the storage cloud system 40 according to the present embodiment stores data stored in the storage pool 41 in which the storage node 46 is added in a manner of evenly distributing the data to the storage nodes 46 of the storage pool 41 in which the storage node 46 is removed.

In this way, by writing data to the nodes after removal while rebalancing the data, it is possible to ensure redundancy of the storage pool 41 after removal without impairing the data.

When adding the resource, the storage cloud system 40 according to the present embodiment calculates a performance value of data access to the storage pool 41 (storage node 46) in a measurement period, calculates, as the load value, a value based on an accumulated value (read excess area, write excess area) of a difference amount between the calculated performance value and a predetermined threshold (addition IO load threshold) in the measurement period, and determines whether the calculated load value exceeds the predetermined value.

Accordingly, it is possible to prevent unstable addition, such as adding the resource due to a temporary increase in load, and to stabilize the performance of the storage.

When adding the resource, the storage cloud system 40 according to the present embodiment calculates, as the load value, a ratio (read excess ratio, write excess ratio) of the calculated accumulated value (read excess area, write excess area) to an accumulated value (read entire area, write entire area) of the performance value in a period in which the performance value is a predetermined value (100%), and determines whether the calculated ratio exceeds a predetermined ratio.

By executing such normalization processing, it is possible to reliably determine whether to add the resource, and stabilize the performance of the storage.

In the storage cloud system 40 according to the present embodiment, the storage node 46 is implemented as an information processing device in a plurality of information processing devices configured to communicate with one another, and the cluster includes a plurality of storage nodes 46 in the storage pool 41.

In this way, the storage node 46 is implemented as the information processing device in a cloud (for example, a public cloud), and the storage pool 41 includes the storage node 46. The storage cloud system 40 according to the present embodiment can stabilize the performance of the cloud storage even with such a hybrid cloud configuration.

The storage cloud system 40 according to the present embodiment, when receiving an instruction to change a capacity of the storage pool 41 (volume 42) from the user terminal 10, changes the capacity of the storage pool 41 according to the change instruction only when a capacity indicated by the change instruction does not exceed a contracted capacity, adds the resource without changing the capacity of the storage pool 41 by the addition determination processing s51, and removes the resource without changing the capacity of the storage pool 41 by the removal determination processing s53.

Accordingly, it is possible to prevent the storage pool 41 (volume 42) from exceeding the contracted capacity, and prevent data from being impaired when removing the resource.

The storage cloud system 40 according to the present embodiment receives an input of each threshold from the threshold management table 400.

Accordingly, it is possible to appropriately change the resource according to a configuration of the storage pool 41 (volume 42) to be used by a user.

The invention is not limited to the above embodiments, and can be implemented using any components without departing from the gist of the invention. The embodiments and modifications described above are merely examples, and the invention is not limited to the contents thereof as long as the characteristics of the invention are not impaired. Although various embodiments and modifications have been described above, the invention is not limited to the contents thereof. Other aspects conceivable within the scope of a technical idea of the invention are also included within the scope of the invention.

For example, a part of the hardware provided in each device according to the present embodiment may be provided in another device.

Programs of each device may be provided in another device, a certain program may include a plurality of programs, or a plurality of programs may be integrated into one program.

The performance value of data access may be acquired by a predetermined function provided in advance in the storage cloud system 40.

The method for determining the magnitude of the load related to data access described in the present embodiment is an example, and various modifications can be assumed.

What is claimed is:

1. A storage system comprising:
an arithmetic device configured to execute
addition processing of calculating a load value of a storage in which a predetermined cluster configuration is set, determining whether the calculated load value exceeds a predetermined value, and adding a predetermined resource to the storage when the calculated load value exceeds the predetermined value, and
removal processing of calculating a predicted value of a load of the storage when the resource is removed after the resource is added, determining whether the calculated predicted value is lower than a predetermined value, and removing the resource of the storage when the calculated predicted value is lower than the predetermined value.

2. The storage system according to claim 1, wherein
in the addition processing, the arithmetic device calculates the load value of the storage in which predetermined processing performance and the predetermined cluster configuration are set, determines whether the calculated load value exceeds the predetermined value, and improves the processing performance or adds a node constituting a cluster of the storage when the calculated load value exceeds the predetermined value, and
in the removal processing, the arithmetic device calculates the predicted value when the processing performance is decreased or the node is removed after the processing performance is improved or the node is added, determines whether the calculated predicted value is lower than the predetermined value, and decreases the processing performance of the storage or removes the node of the storage when the calculated predicted value is lower than the predetermined value.

3. The storage system according to claim 2, wherein
in the addition processing, the arithmetic device calculates load values related to data reading and data writing to the storage in which the predetermined processing performance and the predetermined cluster configuration are set, improves the processing performance when the calculated load value related to data reading exceeds the predetermined value, and adds the node constituting the cluster of the storage when the calculated load value related to data writing exceeds the predetermined value, and
in the removal processing, the arithmetic device calculates predicted values related to data reading and data writing when the processing performance is decreased or the node is removed after the processing performance is improved or the node is added, and decreases the processing performance or removes the node when the calculated predicted values related to data reading and data writing are lower than predetermined values.

4. The storage system according to claim 3, wherein
in the removal processing, when removing the node of the storage in which the node is added, the arithmetic device stores data stored in the storage in which the node is added in a manner of evenly distributing the data to each node of the storage in which the node is removed.

5. The storage system according to claim 1, wherein
in the addition processing, the arithmetic device calculates a performance value of data access to the storage in a predetermined period, calculates, as the load value, a value based on an accumulated value of a difference amount between the calculated performance value and a predetermined threshold in the predetermined period, and determines whether the calculated load value exceeds the predetermined value.

6. The storage system according to claim 5, wherein
in the addition processing, the arithmetic device calculates the accumulated value of the difference amount between the calculated performance value and the predetermined threshold in the predetermined period, calculates, as the load value, a ratio of the calculated accumulated value to an accumulated value of the performance value in a period in which the performance value is a predetermined value, and determines whether the calculated load value exceeds the predetermined value.

7. The storage system according to claim 2, wherein
the node is implemented as an information processing device in a plurality of information processing devices configured to communicate with one another, and the cluster includes a plurality of nodes in the storage.

8. The storage system according to claim 1, wherein
the arithmetic device
executes, when receiving an instruction to change a capacity of the storage from another information processing device, capacity change processing of changing the capacity of the storage according to the change instruction only when a capacity indicated by the change instruction does not exceed a predetermined capacity,
adds the predetermined resource without changing the capacity of the storage in the addition processing, and
removes the predetermined resource without changing the capacity of the storage in the removal processing.

9. The storage system according to claim 1, wherein
the arithmetic device receives inputs of the predetermined value in the addition processing and the predetermined value in the removal processing.

10. A method for controlling a storage system, the method comprising:
executing, by an information processing device,
addition processing of calculating a load value of a storage in which a predetermined cluster configuration is set, determining whether the calculated load value exceeds a predetermined load value, and adding a predetermined resource to the storage when the calculated load value exceeds the predetermined load value; and
removal processing of calculating a load value of the storage when the resource is removed after the resource is added, determining whether the calculated load value is lower than a predetermined load value, and removing the resource of the storage when the calculated load value is lower than the predetermined load value.
